(19) United States
(12) Patent Application Publication
(10) Pub. No.: US 2007/0113589 A1
(43) Pub. Date: May 24, 2007

(54) Gas Control Device and Corresponding Method for Recovering Coolant Gases in a Fiber Coolant System

(76) Inventor: Joseph E. Paganessi, Burr Ridge, IL (US)

Correspondence Address: AIR LIQUIDE, 2700 POST OAK BOULEVARD, SUITE 1800, HOUSTON, TX, 77056, US

(21) Appl. No.: 11/531,385

(22) Filed: Sep. 13, 2006

Related U.S. Application Data
(60) Provisional application No. 60/738,365, filed on Nov. 18, 2005.

(51) Int. Cl. C03B 25/00; C03B 37/10; C03B 5/44; F27B 7/38

(52) U.S. Cl. 65/434; 65/510; 65/481

(57) ABSTRACT

A gas control device for a fiber cooling system includes an inner fiber flow passage extending in a longitudinal direction of the device to facilitate travel of a fiber through the device. The device further includes a chamber that is separated from and at least partially surrounds the inner fiber flow passage, a flow stabilizer region that facilitates and controls gas flow between the inner fiber flow passage and the chamber, and a gas flow port in fluid communication with the chamber to facilitate withdrawal of gas from the inner fiber flow passage into the chamber and removal of the withdrawn gas from the chamber and the device during travel of the fiber through the device.

### CROSS-REFERENCE TO RELATED APPLICATIONS

This application claims priority from U.S. Provisional Patent Application Ser. No. 60/738,365, entitled “System for Recovery of Helium”, and filed Nov. 18, 2005. The disclosure of this provisional patent application is incorporated herein by reference in its entirety.

### BACKGROUND

1. Field

The disclosure pertains to gas control devices to control gas flow within cooling tubes or chambers during processing of fibers, particularly optical fibers.

2. Related Art

Optical fibers are typically formed by a process in which hot fibers are drawn from the end of a massive silica or glass preform that has been heated up to its softening point in a drawing furnace. This drawing process is followed by cooling the fibers within a heat exchanger or cooling tube utilizing a coolant gas that flows through the cooling tube in a co-current or countercurrent direction with respect to the velocity vector of the fiber traveling through the exchanger. The drawn fibers must be cooled to a sufficient temperature within the cooling tube prior to further processing (e.g., cladding the fiber with a heat sensitive protective coating).

Utilizing a relatively inert coolant gas such as helium provides a safe and efficient gaseous heat exchange agent for cooling the hot drawn fibers at the desired rate and to the desired temperatures within the cooling tube. However, one problem with utilizing helium is the excessive loss of this gas through the inlet and outlet ends of the cooling tube into the surrounding atmosphere during cooling of the fiber. Keeping the loss of helium and/or other coolant gases from the cooling tube to a minimum during operation is highly desirable to maximize cooling efficiencies within the cooling tube and minimize operating costs.

Another problem relates to minimization of the amount of air that may be drawn into the cooling tube from the surrounding atmosphere and thus mix with the flowing helium and/or other coolant gases within the heat exchanger. For example, the entry of air into the cooling tube can significantly alter the cooling rate of the fiber moving through the cooling tube due to the poor heat transfer characteristics of helium/air mixtures versus substantially pure helium.

### SUMMARY

A gas control device is provided for a fiber cooling system that effectively recovers coolant gases utilized within the cooling system and also minimizes or prevents the flow of air into the cooling system as well as turbulent gas flow conditions from occurring within the cooling system.

In particular, a gas control device for a fiber cooling system comprises an inner fiber flow passage extending in a longitudinal direction of the device to facilitate travel of a fiber through the device. The device further comprises a chamber that is separated from and at least partially surrounds the inner fiber flow passage, a flow stabilizer region that facilitates and controls gas flow between the inner fiber flow passage and the chamber, and a gas flow port in fluid communication with the chamber to facilitate withdrawal of gas from the inner fiber flow passage into the chamber and removal of the withdrawn gas from the chamber and the device during travel of the fiber through the device.

A method is also provided for cooling a fiber and controlling gas flows around the fiber in a fiber cooling system. The method comprises moving the fiber through a fiber flow passage of a cooling tube, flowing a coolant gas into the fiber flow passage of the cooling tube to facilitate cooling of the fiber within the cooling tube, and selectively withdrawing gas proximate the moving fiber with a gas control device. The gas control device includes an inner fiber flow passage that communicates with the fiber flow passage of the cooling tube and that receives the moving fiber, a chamber that is separated from and at least partially surrounds the inner fiber flow passage of the device, a flow stabilizer region that facilitates and controls gas flow between the inner fiber flow passage and the chamber of the device, and a gas flow port in fluid communication with the chamber, wherein gas is withdrawn from the inner flow passage of the device and into the chamber of the device via the flow stabilizer region, and the withdrawn gas is removed from the chamber into the gas flow port.

The gas control device facilitates withdrawal of gas from the inner fiber flow passage in a substantially uniform and circumferentially expanding direction so as to minimize or eliminate turbulent gaseous currents from forming around the fiber during such gas withdrawal.

The above and still further features and advantages will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a cross-sectional side view in elevation of a first embodiment of a gas recovery cap secured to a cooling tube of a fiber cooling system.

FIG. 2 is a top view in plan of the gas recovery cap that is secured to the cooling tube of the fiber cooling system of FIG. 1.

FIG. 3 is a cross-sectional side view in elevation of a second embodiment of a gas recovery cap secured to a cooling tube of a fiber cooling system.

FIG. 4 is a cross-sectional side view in elevation of a third embodiment of a gas recovery cap secured to a cooling tube of a fiber cooling system.

FIG. 5 is a top view in plan of the gas recovery cap that is secured to the cooling tube of the fiber cooling system of FIG. 4.

FIG. 6 is a cross-sectional side view in elevation of a fourth embodiment of a gas recovery cap secured to a cooling tube of a fiber cooling system.

### DESCRIPTION OF PREFERRED EMBODIMENTS

The gas control and recovery device described herein is configured for engagement with a cooling tube for a fiber cooling system, such as an optical fiber cooling system. As noted above, an optical fiber is formed by drawing a hot fiber from the end of a silica or glass preform that has been heated up to its softening point in a drawing furnace. The hot fiber is then cooled in a suitable elongated heat exchanger that includes a cooling tube through which the fiber is directed. The cooling tube can have any suitable cross-sectional geometry (e.g., circular, square, rectangular, etc.) and has suitable cross-sectional and longitudinal dimensions that facilitate sufficient cooling of the fiber traveling through the cooling tube. The components of the gas recovery devices described herein and the cooling tube can be constructed of any suitable materials including, without limitation, metals (e.g., stainless steel), metal alloys, suitable plastic or polymer materials, and combinations of such materials.

A coolant gas is also injected into the cooling tube to facilitate heat exchange with the hot fiber so as to cool the fiber within the tube. The coolant gas can be injected in a co-current or countercurrent direction in relation to the direction of travel of the fiber through the cooling tube. The coolant gas may be any one or a combination of suitable cooling gases including, without limitation, helium, neon, argon, krypton, xenon, hydrogen, nitrogen, and carbon dioxide. Helium is a preferred coolant gas for cooling optical fibers. However, in certain embodiments, a combination of different coolant gases may be desirable to optimize heat exchange for a particular fiber cooling application.

The gas recovery device facilitates recovery of at least some or a substantial portion of coolant gas from the cooling tube, while preventing or minimizing the potential for turbulence that may occur around the fiber within the cooling tube as the gas is being withdrawn. The gas recovery device further minimizes or prevents air from entering at the inlet or outlet of the cooling tube as the fiber travels through the tube and is cooled.

In exemplary embodiments, such as the embodiments described below, the gas recovery device is provided as an enclosure or cap that surrounds the inlet and/or outlet of the cooling tube and is configured to monitor and control the flow of gases flowing within the cooling tube. In other embodiments, the gas recovery device can be provided at one or more selected locations within the cooling tube rather than as a cap disposed at an inlet end or an outlet end of the cooling tube.

The gas recovery device includes a hollow interior or inner fiber flow path or channel that preferably extends axially through the device to facilitate an inner flow path for a fiber traveling into and through the cooling tube. In addition, the gas recovery device preferably includes a pressure port to measure and monitor the pressure within the inner fiber flow passage of the gas recovery device, and a gas withdrawal port that selectively withdraws gases from the flow passage.

The gas recovery device is further preferably designed such that gas is withdrawn radially and in a substantially uniform and circumferentially expanding manner from the inner fiber flow passage into an annular plenum or chamber that is separated from and surrounds at least a portion of the inner fiber flow passage within the device. A flow stabilizer orifice is provided that surrounds or is circumferentially oriented with respect to a portion of the inner fiber flow passage and facilitates fluid communication between the flow passage and the annular chamber. The design of the annular chamber and flow stabilizer orifice with respect to the inner fiber flow passage within the device facilitates a substantially uniform pressure drop between the flow passage and the annular chamber during such gas withdrawal. Withdrawal of the gas from the device in this manner significantly reduces or eliminates the potential for turbulence around the fiber, thus minimizing or preventing the potential for vibration, disturbance or damage to the fiber. Thus, the gas recovery device facilitates the collection and recovery of coolant gases, such as helium, from the cooling tube for recycling or reuse of the coolant gases. The gas recovery device further withdraws any ambient air that may enter the device, thus preventing or minimizing the presence of air in the cooling tube during cooling of the fiber.

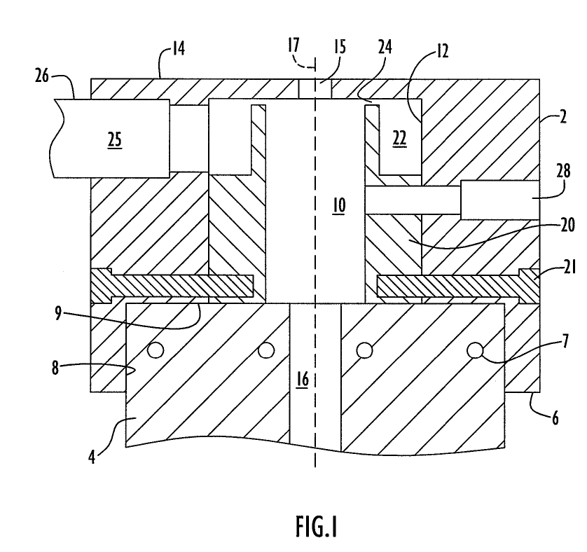

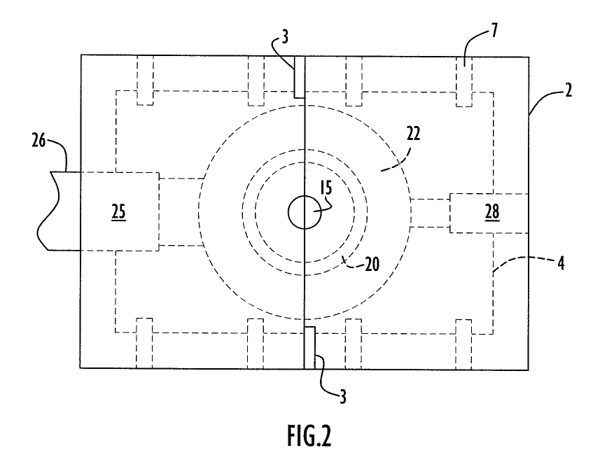

An exemplary embodiment of a gas recovery device is depicted in FIGS. 1 and 2. The gas recovery device is configured as a cap including a hollow housing 2 that fits around an inlet or outlet end of a hollow cooling tube 4, where the cooling tube is disposed within a fiber production system at a suitable location downstream from a preform furnace. The hollow cooling tube 4 can have any suitable length (e.g., a length in the range of about 1 meter to about 3 meters) to facilitate sufficient residence time of the fiber within the cooling tube during cooling of the fiber. A coolant gas is injected within the cooling tube at a selected location along the length of the cooling tube. Alternatively, the coolant gas can be injected at a suitable location upstream from the cooling tube, where the fiber travels with the coolant gas into the cooling tube.

Both the gas recovery cap and the cooling tube can include an axially split or “clam-shell” configuration, where the components of the cap and tube are separated along their axial dimensions into two or more sections (e.g., with hinged sections). As can be seen in FIG. 2, one or more sealing members 3 (e.g., gaskets) are preferably provided between the split sections of the gas recovery cap housing and the cooling tube to maintain a gas-tight seal when the sections are secured together. The split configuration allows a fiber to be initially drawn from a preform furnace to a take-up spindle at the outset of the fiber forming process, where the fiber can be easily guided through the open or split gas recovery cap and cooling tube. The cap and cooling tube can then be closed once the fiber has been wound onto the spindle.

A first end 6 of cap housing 2 includes an opening or recess defined by interior side walls 8 that extend from the first end to an end wall 9 of the recess. The recess is suitably dimensioned to receive and engage with an end (e.g., an inlet or outlet end) of cooling tube 4. The first end of the cap housing is secured to the cooling tube with one or more suitable fasteners 7 (e.g., mounting screws) that extend transversely through the cap housing at the recess to secure the cooling tube end to recess side walls 8. The cap housing is secured to the cooling tube in a suitable manner to facilitate a gas tight seal at such connection. Optionally, gaskets or other suitable sealing members can also be provided at the first end of the cap housing to ensure a gas tight seal is maintained between the cap and the cooling tube during operation.

The recess of cap housing 2 extends from the first end 4 to a cavity 10 that has a smaller cross-sectional dimension (e.g., diameter) than the cross-sectional dimension of the recess. The cavity 10 is defined by sidewalls 12 that extend from the recess end wall 9 toward a second end 14 of the housing. The second end 14 of housing 2 includes an opening or fiber orifice 15 that communicates with cavity 10. The fiber orifice 15 is much smaller in dimension (e.g., diameter) than the transverse cross-sectional dimension of the cavity 10. In addition, the fiber orifice 15, cavity 10 and recess of the cap housing are all suitably dimensioned and aligned with each other to provide a central or axial and substantially linear pathway that extends through the cap and corresponds with a fiber flow passage 16 defined within and extending through cooling tube 4.

An annular member or ring 20 is provided within the cavity 10 of housing 2. The ring 20 is suitably dimensioned with outer peripheral wall portions that engage with cavity walls 12. The passage through the ring 20, which is formed by the ring inner diameter, defines an inner fiber flow path or channel (indicated by dashed line 17 in FIG. 1) that is aligned and in fluid communication with fiber flow passage 16 of the cooling tube.

The ring is located along the cavity walls 12 with a first end surface that is generally coplanar with end wall 9. As can be seen in FIG. 1, ring 20 can be secured within housing 2 such that its first end surface is adjacent the end of cooling tube 4 when the cooling tube is secured to the first end of the cap. Optionally, sealing members (e.g., gaskets) can be provided at the interface between the first end surface of the ring and the cooling tube end to ensure a gas tight seal is established at this engagement. The ring 20 is secured within the cap housing 2 with suitable fasteners 21 (e.g., screws) that extend transversely through portions of the housing and the ring.

The ring 20 extends toward and terminates at a second end surface that is proximate an interior wall surface of the cap housing second end 14, such that a slight gap is defined between the second end surface of the ring and the interior wall surface of the second end 14. The ring 20 further includes a removed annular portion or reduced thickness section that extends from the ring second end surface to the ring outer peripheral wall portions that engage cavity walls 12, such that the wall thickness of the ring at the second end is reduced and considerably less than the wall thickness of the ring at the first end. An annular chamber 22 is thus defined between portions of the housing cavity walls 12 and reduced wall thickness portions of ring 20.

The gap between the second end of ring 20 and the interior wall surface of the housing first end is in fluid communication with annular chamber 22 and defines an annular shaped flow stabilizer orifice 24. The flow stabilizer orifice 24 surrounds or is circumferentially oriented around a portion of the inner fiber flow path or channel 17 extending axially within the housing 2 and facilitates flow of gas from the fiber flow passage to the annular chamber defined between the ring and cap housing.

The gas recovery cap further includes a gas withdrawal channel or port 25 that extends transversely through housing 2 at a suitable location so as to be in fluid communication with annular chamber 22. Port 25 connects with a suitable flow line 26 to facilitate withdrawal of gas from cavity 10 and annular chamber 22 during system operation. One or more valves can be provided within port 25 and/or flow line 26 to facilitate selective control of gas flow through the port. In addition, a suitable pressure control device (e.g., a pump or blower) can be provided within flow line 26 as an alternative to or in combination with a valve to selectively control withdrawal of gas from the cap by establishing a vacuum within the flow line. Further, one or more pressure, flow rate and/or concentration sensors can be provided within port 25 and/or line 26 to monitor the flow of gases (and amount of air in such gases) being removed from the cap during operation.

A pressure sensor port 28 is also provided in the gas recovery cap to monitor pressure within cavity 10 and the fiber flow passage during operation. Port 28 extends transversely through cap housing 2 and ring 20 so as to be in fluid communication with the inner fiber flow passage 17 within the cap housing. A suitable pressure sensor is provided within port 28 (or a fluid flow line connected with the port) to measure and monitor at least one of a pressure within the fiber flow passage and a differential pressure between the fiber flow passage and the ambient environment external to the gas recovery cap during operation. For example, the pressure sensor port can be configured to monitor a differential pressure at the fiber orifice 15. Any change in pressure can be communicated to an operator or, optionally, a controller, to facilitate manual or automatic control of the gas withdrawal port 24 (e.g., via control of one or more valves and/or operation of a vacuum source) to control the amount of gas extracted from the fiber flow passage.

Each of the fiber orifice 15, flow stabilizer orifice 24, annular chamber 22, fiber flow passage within the cap 2 and fiber flow passage 16 within the cooling tube 4 are suitably dimensioned to facilitate a generally laminar flow of coolant gases through the fiber flow passage as well as a radial and generally uniform withdrawal of gas from the inner fiber flow passage 17 to annular chamber 22 within the cap housing. The dimension of the fiber orifice 15 in the cap is selected based upon the transverse cross-sectional dimension of the flow path 16 within the cooling tube 4. Preferably, the maximum transverse cross-sectional dimension (e.g., diameter) of the fiber orifice 15 is no greater than the transverse cross-sectional dimension of the fiber flow passage 16 within the cooling tube 4. In addition, the flow stabilizer orifice 24 is preferably suitably dimensioned to ensure that, during operation, the pressure drop or differential pressure across orifice 24 is less than the differential pressure across fiber orifice 15. This in turn ensures a uniform radial withdrawal of gases from the flow passage 17 into annular chamber 22 (e.g., for recovery by gas withdrawal port 25).

The transverse cross-sectional dimension of the inner fiber flow passage 17 within the gas recovery cap 2 (which is defined by the inner diameter dimension of ring 20) is selected to maintain a laminar flow of gas within this region. In particular, it is preferable to provide the inner fiber flow passage of the gas recovery cap with a transverse cross-sectional dimension (i.e., provide an inner diameter of ring 20) that is greater than the transverse cross-sectional dimensions of each of the fiber orifice for the cap and the fiber flow passage of the cooling tube.

Preferably, the dimensions of the ring, fiber orifice and cooling tube fiber flow passage can be selected such that the transverse cross-sectional dimension of the inner fiber flow passage of the cap (i.e., the inner diameter of the cap housing ring) is at least twice as large as the dimension of the fiber orifice and the transverse cross-sectional dimension of the cooling tube fiber flow passage. In an exemplary embodiment, the components of the gas recovery cap and the cooling tube are suitably dimensioned such that the fiber orifice of the cap has a diameter of about 6 millimeters, the cap housing ring has an inner diameter of about 15 millimeters, and the cooling tube fiber flow passage has a diameter of about 7 millimeters.

In operation, gas recovery cap housing 2 is secured to an end of a fiber cooling tube 4. The gas recovery cap can be secured to an inlet or an outlet end of the cooling tube. Optionally, a gas recovery cap can be secured to both inlet and outlet ends of the cooling tube. For example, a gas recovery cap may be secured to an inlet end of the cooling tube to control and remove the flow of air that may enter the housing with a fiber moving through the housing and into the cooling tube. A gas recovery cap may also be secured to an outlet end of the cooling tube to remove and recover coolant gases that have been used to cool the fiber within the cooling tube. At the outlet end of the cooling tube, the gas recovery cap can further be used to withdraw any air that may enter through the outlet end.

The pressure sensor port 28 facilitates the monitoring of the pressure within the inner fiber flow passage and/or a differential pressure at the fiber orifice 15. This pressure or pressure differential is monitored manually (e.g., by an operator) or automatically (via controller), and the amount of gas that is withdrawn into the gas withdrawal port 25 and flow line 26 is controlled accordingly (manually or automatically) by controlling operation of valves and/or the pressure control device as noted above. Gas within the inner flow path of housing 2 is withdrawn through flow stabilizer orifice 24, into annular chamber 22 and port 25, and through flow line 26.

When the gas recovery cap is operated without the need for recovering coolant gases (e.g., at the inlet and/or outlet ends of the cooling tube), the pressure within the inner fiber flow passage of the cap can be slightly larger than the ambient pressure surrounding the cooling tube (e.g., atmospheric pressure). This will minimize or substantially prevent air from entering the cooling tube. However, when recovery of the coolant gases is desired (e.g., at the outlet end of the cooling tube), it is preferable to maintain the pressure within the inner fiber flow passage of the gas recovery cap at about the same pressure or slightly less than the ambient pressure surrounding the cap and cooling tube. Preferably, the pressure within the recovery cap and cooling tube is adjusted during operation, via the one or more valves and/or pressure control device disposed in the gas withdrawal port or flow line, such that a slight negative pressure or vacuum exists within the cap housing (i.e., a difference in pressure between the ambient pressure and the pressure at the interior of the cap housing) of no more than about 0.025 kPa.

The design of annular chamber 22, in combination with the selection of suitable dimensions for the fiber flow passage, the flow stabilizer orifice and the fiber orifice of the gas recovery cap, facilitates a generally uniform withdrawal of gas in a radial and generally circumferentially expanding manner from inner fiber flow passage 17, through flow stabilizer orifice 24 and into the annular chamber. The gas within annular chamber 22 is then withdrawn through port 25 and into flow line 26. Such uniform withdrawal of gas away from the fiber disposed in the inner fiber flow passage reduces or eliminates any potential turbulent effect of gaseous currents that might otherwise be generated, thus minimizing the potential for generating undesirable vibrations and damage to the fiber.

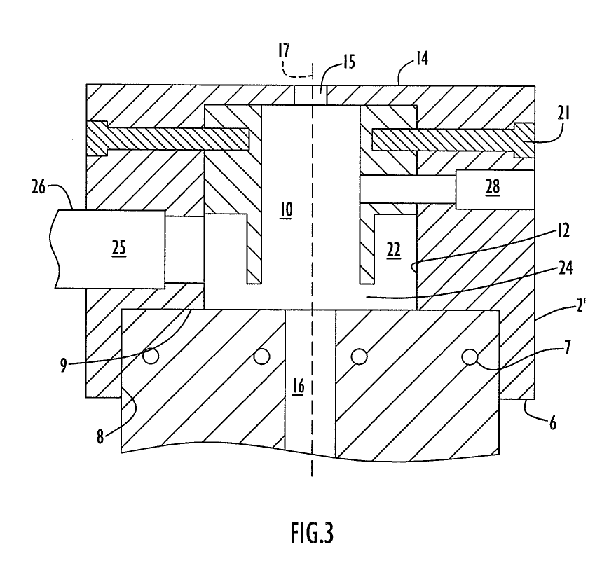

The design of the gas recovery cap can be modified in any number of different ways and is thus not limited to the embodiment described above and depicted in FIGS. 1 and 2. For example, the orientation of ring 20 within cap housing 2 can be rotated by 180° as shown in another embodiment of the cap depicted in FIG. 3. In other words, the gas recovery cap of FIG. 3 is configured such that the annular chamber 22 and flow stabilizer orifice 24 are located closer to the housing first end 6 than housing second end 14. In this embodiment, gas withdrawal port 25 is also suitably positioned along housing 2′ so as to be aligned with and in fluid communication with annular chamber 22. The annular shaped flow stabilizer orifice 24 is also disposed proximate the cooling tube end so as to be in fluid communication with the annular chamber. The gas recovery cap of FIG. 3 operates in a similar manner as the cap described above and depicted in FIGS. 1 and 2, with gas being withdrawn in a generally uniform and radial manner away from a central portion of the inner fiber flow passage along which a fiber travels within the cap.

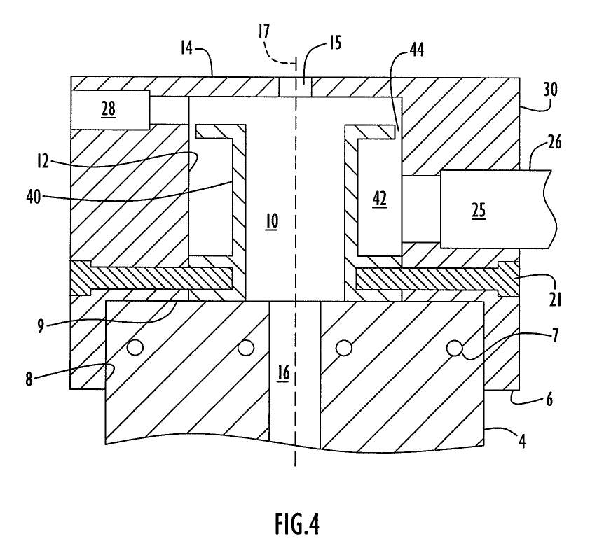

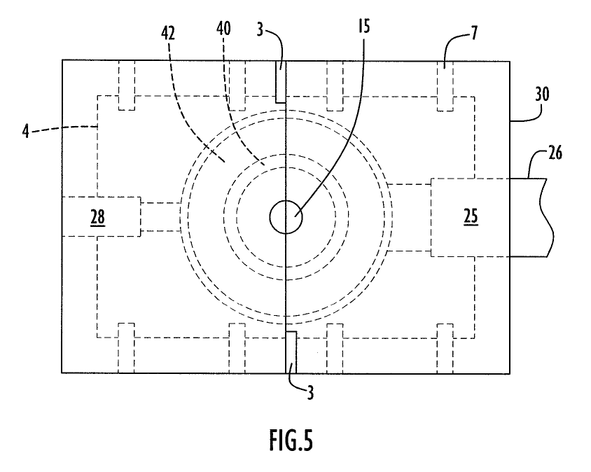

Another embodiment of a gas recovery cap is depicted in FIGS. 4 and 5. In this embodiment, cap housing 30 is substantially similar in design as the cap housing of FIGS. 1 and 2, including a first end 6 with a recess that engages with an inlet or outlet end of a cooling tube 4 and a second end 14 that includes a fiber orifice 15. A ring 40 is disposed within housing cavity 10 and is suitably dimensioned such that outer peripheral wall portions of the ring engage with the housing cavity walls. The ring includes a first end that is disposed near recess end wall 9 so as to engage with the cooling tube end in a similar manner as described above for the previous embodiment. Fasteners 21 extending transversely through housing 30 into ring 40 retain the ring in its position within the housing. The inner diameter of ring 40 further defines the inner fiber flow passage 17 through which a fiber travels during operation. The dimensions of the fiber flow passage within the cap, the fiber orifice of the cap and the cooling tube fiber flow passage are similar to those described above for the previous embodiment.

A second end of the ring 40 terminates a selected distance from the housing second end 14, thus leaving a gap between the second end of the ring and an interior surface of housing second end 14. Pressure sensor port 28 extends transversely through housing 40 at a location corresponding with the gap between the ring and the housing second end so as to be in fluid communication with the cavity 10 and the inner fiber flow passage 17 within the cap housing. As with the previous embodiment, a suitable pressure sensor is provided within port 28 to measure and monitor at least one of the pressure within the fiber flow passage and the differential pressure at the fiber orifice during operation.

The ring 40 includes a removed annular portion or reduced thickness section that is formed between but does not completely extend to each of the first and second end surfaces of the ring. Annular chamber 42 is thus defined between portions of the housing cavity walls 12 and reduced wall thickness portions located between the first and second ends of the ring 20. In addition, the second end of the ring has an outer diameter that is slightly smaller than the outer diameter of the first end of the ring, such that a slight space or gap exists between the ring second end and the cavity walls 12 in the housing 30. This gap defines an annular flow stabilizer orifice 44 at the ring second end that provides fluid communication between annular chamber 42 and the inner fiber flow passage 17.

Gas withdrawal port 25 extends transversely through housing 30 at a location that corresponds with annular chamber 42, such that port 25 is in fluid communication with the annular chamber. The gas withdrawal port is substantially similar to the gas withdrawal port described above and depicted in FIGS. 1 and 2, and the port connects with a suitable flow line 26 to facilitate withdrawal of gas from cavity 10 and annular chamber 22 during system operation. As in the previous embodiment, one or more valves can be provided within port 25 and/or flow line 26 to facilitate selective control of gas flow through the port. In addition, a suitable pressure control device (e.g., a pump or blower) can be provided within flow line 26 as an alternative to or in combination with a valve to selectively control withdrawal of gas from the cap by establishing a vacuum within the flow line. Optionally, one or more pressure, flow rate and/or concentration sensors can be provided within port 25 and/or line 26 to monitor the flow of gases (and amount of air in such gases) being removed from the cap during operation.

The gas recovery cap of FIGS. 4 and 5 operates in a similar manner as the previous embodiments, where gas is withdrawn in a radial, circumferentially expanding and generally uniform manner from the inner fiber flow passage within housing 30, through flow stabilizer orifice 44 and into gas withdrawal port 25 and flow line 26. In addition, the pressure differential at the fiber orifice 15 (i.e., the difference in pressure between the inner fiber flow passage 17 within housing 30 and the ambient environment surrounding the housing) can be selectively adjusted and controlled to generate a vacuum or slight negative pressure within the housing so as to draw coolant gas and/or air into gas withdrawal port 25 during system operation.

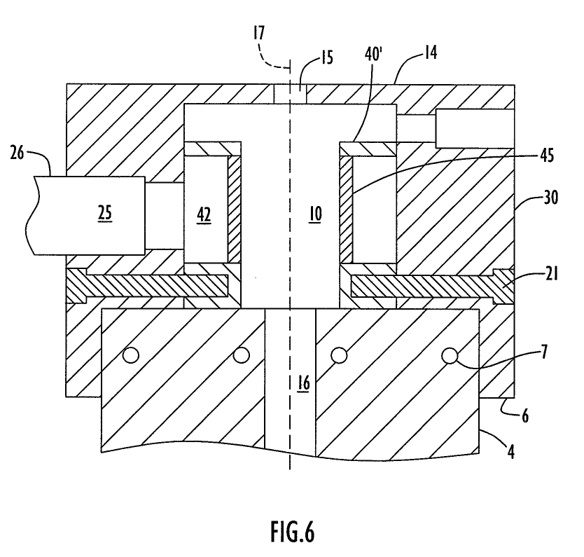

The ring of the gas recovery cap of FIGS. 4 and 5 can be modified to replace the flow stabilizer orifice with a membrane through which gaseous fluids can flow from the inner fiber flow passage to the annular chamber. Referring to FIG. 6, housing 30 includes a ring 40′ that is similar in design to the ring described in the previous embodiment, with the exception that the second end of the ring has an outer diameter that is the same as the outer diameter of the first end of the ring (thus eliminating the gap or flow stabilizer orifice between the ring second end and the cavity walls of the housing).

In addition, the thin wall thickness section that extends between the first and second ends and defines a major portion of the inner diameter of ring 40′ is formed from a porous membrane material 45. The porous membrane material is annular in configuration and surrounds or is circumferentially oriented around a portion of the inner fiber flow passage disposed within the housing. The porous membrane material 45 has a suitable porosity that permits coolant gases and air to flow from the inner fiber flow passage within housing 30, through membrane material 45 and into annular chamber 42. The porous membrane material can be a metal mesh material or any other suitably porous material (e.g., a porous polymer) that facilitates gas flow through the material.

Operation of the gas recovery cap of FIG. 6 is similar to that of the previous embodiments, where gas flows in a radial, circumferentially expanding and generally uniform manner from the fiber inner flow path 17 within the housing 30, through membrane 45 and into gas withdrawal port 25 and flow line 26. Thus, the annular shaped membrane stabilizes the flow of gas between the inner fiber flow passage and the annular chamber in a similar manner as the previous embodiments to minimize or prevent undesirable turbulence and potential damage to the fiber during withdrawal of gases from the cap.

While the previous embodiments describe a cap or member that is secured or securable to an inlet or outlet end of a cooling tube, the gas recovery device is not limited to such cap embodiments. Rather, the gas recovery device can be disposed within the cooling tube (e.g., at a selected location between the inlet and outlet ends of the cooling tube).

In addition, in certain applications, the gas withdrawal port can be configured to generate a positive pressure rather than a negative pressure or suction. For example, for applications in which one or more gas recovery devices are implemented near the inlet and/or outlet ends of the cooling tube (e.g., as gas recovery cap devices), it may be desirable to provide a slightly higher pressure within the device than the ambient pressure so as to prevent any air from entering the cooling tube. The uniform and circumferential manner in which the pressure is applied within the inner fiber flow passage, via the flow stabilizer orifice (or annular porous membrane section) substantially minimizes or prevents turbulence around and disturbance to the fiber traveling through the device.

Further, the device is not limited to an annular shaped flow stabilizer orifice (or porous membrane) and annular chamber. Rather, any one or more orifices (or membranes) that provide fluid communication between the inner fiber flow passage and one or more chambers at least partially surrounding the flow passage can be provided within the device that facilitates generally uniform and radial withdrawal of gases from the flow passage to the chamber. For example, a plurality of separate and distinct chambers can be defined within the device that at least partially surround and communicate with the inner fiber flow passage via a plurality of orifices (or porous membranes) which also are aligned to at least partially surround the flow passage.

Having described novel gas recovery devices and corresponding methods for recovering coolant gases in a fiber coolant system, it is believed that other modifications, variations and changes will be suggested to those skilled in the art in view of the teachings set forth herein. It is therefore to be understood that all such variations, modifications and changes are believed to fall within the scope as defined by the appended claims.

1. A gas control device for a fiber cooling system, the gas control device comprising:
an inner fiber flow passage extending in a longitudinal direction of the device to facilitate travel of a fiber through the device;
a chamber that is separated from and at least partially surrounds the inner fiber flow passage;
a flow stabilizer region that facilitates and controls gas flow between the inner fiber flow passage and the chamber; and
a gas flow port in fluid communication with the chamber to facilitate withdrawal of gas from the inner fiber flow passage into the chamber and removal of the withdrawn gas from the chamber and the device during travel of the fiber through the device.

2. The device of claim 1, wherein the device is securable to an end of a cooling tube to facilitate travel of the fiber between the inner fiber flow passage of the device and a flow passage within the cooling tube.

3. The device of claim 1, wherein the chamber comprises an annular shaped chamber that surrounds at least a portion of the inner fiber flow passage.

4. The device of claim 3, wherein the flow stabilizer region is annular shaped and provides fluid communication between the annular shaped chamber and the inner fiber flow passage so as to facilitate withdrawal of gas in a circumferentially expanding direction from the inner fiber flow passage into the annular shaped chamber.

5. The device of claim 4, wherein the flow stabilizer region comprises an annular shaped orifice.

6. The device of claim 4, wherein the flow stabilizer region comprises an annular shaped material having a suitable porosity to facilitate gas flow through the material.

7. The device of claim 4, further comprising:
a housing including a cavity disposed within the housing; and
a ring disposed within the cavity of the housing, wherein an inner diameter of the annular member defines at least part of the inner fiber flow passage, and the annular shaped chamber is defined between an outer peripheral wall portion of the ring and an interior wall surface of the housing.

8. The device of claim 7, wherein the device is securable to an end of a cooling tube to facilitate travel of the fiber between the inner fiber flow passage of the device and a flow passage within the cooling tube, and the device includes an orifice disposed at an end of the device to facilitate passage of the fiber through the device.

9. The device of claim 8, wherein the diameter of the fiber orifice of the device is no greater than a transverse cross-sectional dimension of the flow passage within the cooling tube, and the inner fiber flow passage of the device is greater than the flow passage within the cooling tube.

10. The device of claim 7, wherein each of the housing and the ring is separable into at least two subsections to facilitate opening of the device and initial feeding of the fiber into the inner fiber flow passage of the device.

11. The device of claim 1, further comprising a pressure sensor port in fluid communication with the inner fiber flow passage and configured to facilitate a determination of a pressure within the inner fiber flow passage.

12. A method of cooling a fiber and controlling gas flows around the fiber in a fiber cooling system, the method comprising:
moving the fiber through a fiber flow passage of a cooling tube;
flowing a coolant gas into the fiber flow passage of the cooling tube to facilitate cooling of the fiber within the cooling tube; and
selectively withdrawing gas proximate the moving fiber with a gas control device, the gas control device including an inner fiber flow passage that communicates with the fiber flow passage of the cooling tube and that receives the moving fiber, a chamber that is separated from and at least partially surrounds the inner fiber flow passage of the device, a flow stabilizer region that facilitates and controls gas flow between the inner fiber flow passage and the chamber of the device, and a gas flow port in fluid communication with the chamber, wherein gas is withdrawn from the inner flow passage of the device and into the chamber of the device via the flow stabilizer region, and the withdrawn gas is removed from the chamber into the gas flow port.

13. The method of claim 12, wherein the gas control device comprises a cap secured to an inlet end or an outlet end of the cooling tube.

14. The method of claim 12, wherein the chamber comprises an annular shaped chamber that surrounds at least a portion of the inner fiber flow passage of the gas control device, and the flow stabilizer region is annular shaped and provides fluid communication between the annular shaped chamber and the inner fiber flow passage of the gas control device such that gases proximate the moving fiber are withdrawn in a circumferentially expanding direction from the inner fiber flow passage into the annular shaped chamber of the gas control device.

15. The method of claim 14, wherein the flow stabilizer region comprises one of an annular shaped orifice and an annular shaped material having a suitable porosity to facilitate gas flow through the material.

16. The method of claim 14, wherein the gas control device further comprises a housing including a cavity disposed within the housing, and a ring disposed within the cavity of the housing, an inner diameter of the annular member defining at least part of the inner fiber flow passage of the gas control device, and the annular shaped chamber being defined between an outer peripheral wall portion of the ring and an interior wall surface of the housing.

17. The method of claim 12, further comprising:
measuring a pressure within the inner fiber flow passage of the gas control device; and
controlling an amount of gas withdrawn from the inner fiber flow passage into the chamber of the gas control device based upon the measured pressure.

18. The method of claim 12, wherein the gas withdrawn proximate the fiber includes at least one of helium and air.

19. The method of claim 12, wherein each of the cooling tube and gas control device is separable into at least two subsections, and the method further comprises:
separating each of the cooling tube and gas control device into subsections to facilitate feeding of the fiber into each of the cooling tube and gas control device.

20. A gas control device for a fiber cooling system, the gas control device comprising:
an inner fiber flow passage that facilitates travel of a fiber through the device;
a gas withdrawal means that at least partially surrounds the inner fiber flow passage, the gas withdrawal means for withdrawing gas in a circumferentially expanding direction from the inner fiber flow passage; and
a removal means for removing gas withdrawn by the gas withdrawal means from the device.
